(19) United States
(12) Patent Application Publication
(10) Pub. No.: US 2012/0307298 A1
(43) Pub. Date: Dec. 6, 2012

(54) PRINTING SYSTEM, PRINTER AND PRINT REQUEST CONTROL SERVER

(75) Inventors: Taro ISHIGE, Matsumoto-shi (JP); Nobuyuki KITO, Shiojiri-shi (JP); Hidetsugu OBI, Matsumoto-shi (JP)

(73) Assignee: Seiko Epson Corporation, Shinjuku-ku (JP)

(21) Appl. No.: 13/482,766

(22) Filed: May 29, 2012

(30) Foreign Application Priority Data
Jun. 2, 2011 (JP) 2011-124200
Jan. 16, 2012 (JP) 2012-005949

(51) Int. Cl. G06K 15/02

(52) U.S. Cl. 358/1.15

(57) ABSTRACT

A printing system includes: a given wireless terminal having a print request unit that sends a print request including an identifier and a print target, the wireless terminal being identified by the identifier; a print request control server having a print request receiving unit that receives the print request and a print information sending unit that sends print information corresponding to the print target in association with the identifier; and a printer having a wireless terminal detecting unit that detects the identifier of the given wireless terminal, a print information receiving unit that receives the print information corresponding to the detected identifier from the print request control server, and a print control unit that controls the printing based on the print information.

### CROSS REFERENCES TO RELATED APPLICATIONS

The entire disclosure of Japanese Patent Application No. 2011-124200, filed Jun. 2, 2011 is incorporated by reference herein.

The entire disclosure of Japanese Patent Application No. 2012-005949, filed Jan. 16, 2012 is incorporated by reference herein.

### BACKGROUND

1. Technical Field

The present invention relates to printing systems, printers, print request control servers, and particularly relates to cloud computing systems capable of using a printer by sending messages, files, or the like to a communication account associated with the printer.

2. Related Art

Cloud computing systems that have functions for receiving e-mails and printing the body of those e-mails, files attached to the e-mails, and so on have been known for some time (for example, JP-A-2002-369110). Such a cloud computing system (called simply a “printing system” hereinafter) includes a server that, upon receiving a specific e-mail, generates print data compliant with a specific printer based on the body of the e-mail, a file attached thereto, and so on, and a printer that obtains the print data from the server and executes the printing. Accordingly, a user of the printing system can use a printer registered in the printing system even if printer drivers are not installed in a communication terminal such as a PC (personal computer), a smartphone, or the like. In such a printing system, when a process for registering a printer, which includes allocating an e-mail address for receiving items to be printed to the printer, is carried out in the server, any user that knows the stated e-mail address can use that printer.

However, the stated printing system has a problem in that wasteful printing will be executed if spam is sent to the e-mail address assigned to the printer.

### SUMMARY

It is an advantage of some aspects of the invention to prevent wasteful printing caused by spam in a cloud computing system that enables printers to be used through e-mail or the like.

A printing system according to an aspect of the invention includes: a given wireless terminal having a print request unit that sends a print request including an identifier and a print target, the wireless terminal being identified by the identifier; a print request control server having a print request receiving unit that receives the print request and a print information sending unit that sends print information corresponding to the print target in association with the identifier; and a printer having a wireless terminal detecting unit that detects the identifier of the given wireless terminal, a print information receiving unit that receives the print information corresponding to the detected identifier from the print request control server, and a print control unit that controls the printing based on the print information.

According to this aspect of the invention, when the wireless terminal approaches the printer, the printer can obtain the print information associated with the communication identifier of the wireless terminal. Accordingly, a user located near the printer can cause the printer to obtain the print information corresponding to the print target by sending the print request including the communication identifier of the wireless terminal and the print target to the print request control server. By using the communication identifier of the wireless terminal in this manner when the printer obtains the print information, wasteful printing caused by spam can be prevented.

According to another aspect of the invention, in the printing system, it is preferable that the print request be an e-mail whose destination is an e-mail address that includes the communication identifier.

According to this aspect of the invention, the user can send the print request using a generic e-mail sending function provided in the wireless terminal.

According to another aspect of the invention, in the printing system, it is preferable that the print information include the print target itself.

According to this aspect of the invention, the print target sent by the user reaches the printer as-is through the print request control server. The burden on the print request control server can therefore be reduced.

According to another aspect of the invention, in the printing system, it is preferable that the print request control server further include a print information generating unit that generates the print information by converting the print target.

According to this aspect of the invention, the print request control server can convert the print target into print data suited to the printer and sent that print data to the printer as the print information; it is therefore unnecessary to provide a function for converting print information in various formats into print data in the printer, and it is also possible to cause the printer to execute the printing even from a wireless terminal that does not have a function for converting the print target into print data suited to the printer.

Note that the functions of the various units described in the aspects of the invention are realized by hardware resources in which the functions of the units themselves are specified, hardware resources whose functions are specified by programs, or by a combination of the two. In addition, the functions of these units are not intended to be limited to being realized by hardware resources that are physically independent from each other. Furthermore, the invention can also be realized as a printer, a print request control server configured of a single server computer or a plurality of server computers, a print request control method, a computer program that causes the stated functions to be executed by a computer, and as a recording medium for such a computer program. Of course, the recording medium for such a computer program may be a magnetic recording medium, a magneto-optical recording medium, or a recording medium that will be developed in the future.

### BRIEF DESCRIPTION OF THE DRAWINGS

The invention will be described with reference to the accompanying drawings, wherein like numbers reference like elements.

FIG. 1 is a block diagram illustrating a printing system according to a first embodiment of the invention.

FIG. 2 is a sequence chart illustrating a print control method according to the first embodiment of the invention.

FIG. 3 is a block diagram illustrating a printing system according to a second embodiment of the invention.

FIG. 4 is a sequence chart illustrating a print control method according to the second embodiment of the invention.

FIG. 5 is a block diagram illustrating a printing system according to a third embodiment of the invention.

FIG. 6 is a sequence chart illustrating a print control method according to the third embodiment of the invention.

FIG. 7 is a sequence chart illustrating a print control method according to a variation on the third embodiment of the invention.

### DESCRIPTION OF EXEMPLARY EMBODIMENTS

Hereinafter, several embodiments of the invention will be described with reference to the appended drawings. Note that in the drawings, corresponding constituent elements are given the same reference numerals, and redundant descriptions thereof are omitted.

### First Embodiment

### Printing System

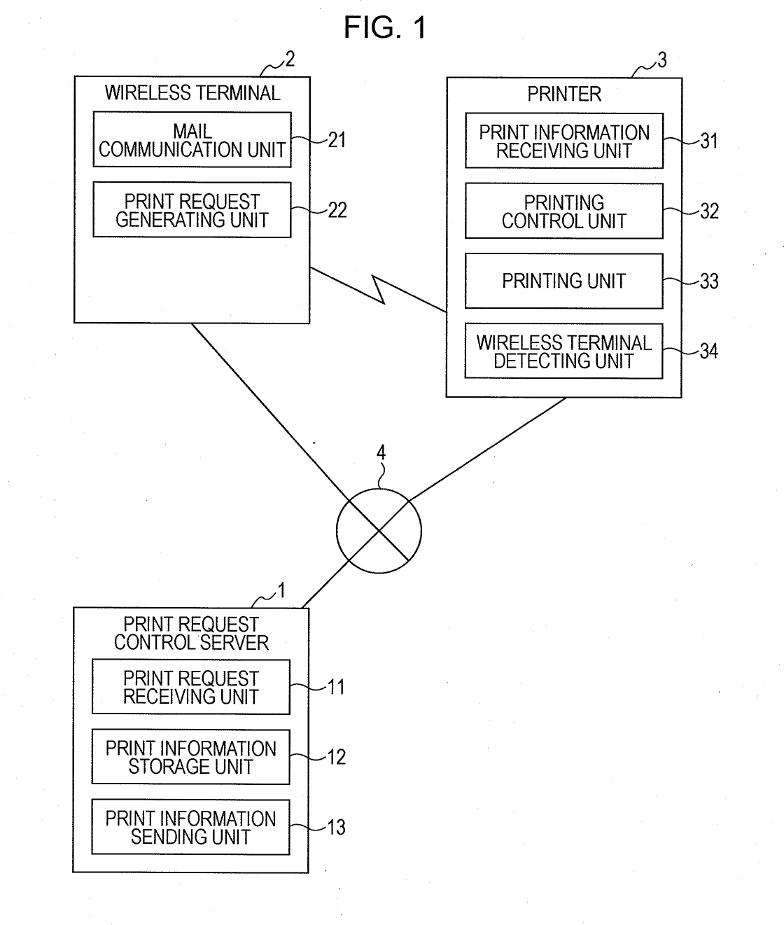

FIG. 1 is a block diagram illustrating a printing system according to a first embodiment of the invention. The printing system is configured as a cloud computing system that is capable of printing the body of an e-mail, a file attached thereto, or the like by sending the e-mail to an e-mail address that includes a communication identifier of a wireless terminal 2, and is configured of a print request control server 1, a printer 3, and a given wireless terminal 2, all of which are connected via the Internet 4.

The print request control server 1 is a computer that functions as an SMTP server. By executing various types of computer programs, the print request control server 1 functions as a print request receiving unit 11 that receives an e-mail serving as a print request, a print information storage unit 12 that stores the received e-mail, and a print information sending unit 13 that sends an e-mail in response to a request. Specifically, the print request control server 1 is a computer that is distinguished on the Internet by a predetermined domain name, and receives and accumulates given e-mails that include that domain name in their addresses. Upon receiving, from an MUA (mail user agent), a request for an e-mail sent to an e-mail address assigned to that MUA, the print request control server 1 sends the requested e-mail to the MUA.

The printer 3 includes a print information receiving unit 31 serving as an MUA for sending and receiving e-mails, a printing control unit 32 that obtains a print target from the e-mail and controls printing based on the print target, a printing unit 33 having a known configuration such as an ink jet system, a laser system, or the like, and a wireless terminal detecting unit 34. The print information receiving unit 31, the printing control unit 32, and the wireless terminal detecting unit 34 are configured by a computer having a processor, a RAM, and an input/output mechanism, and by a known wireless LAN communication circuit. In addition to a function for communicating with another wireless communication device over a wireless LAN, the wireless terminal detecting unit 34 includes a function for obtaining the communication identifier of the other wireless communication device.

The wireless terminal 2 includes a mail communication unit 21 serving as an MUA for sending/receiving e-mails, and a print request generating unit 22 that sends an e-mail (a print request mail) including a print target to an e-mail address that includes the communication identifier of the wireless terminal 2 and the domain name of the print request control server 1. The print request generating unit 22 obtains the communication identifier of the wireless terminal 2, generates an e-mail address that combines the communication identifier with the domain name of the print request control server 1, which has been registered in advance, and sets the generated e-mail address as a destination. An SSID, a MAC address, or the like may be used as the communication identifier. For example, if the communication identifier of the wireless terminal 2 is “xxxxxx” and the domain name of the print request control server 1 is “yyyyyy”, the e-mail address generated by the print request generating unit 22 is “xxxxxx@yyyyyy”. Furthermore, the print request generating unit 22 provides a user interface for selecting a print target. For example, the print request generating unit 22 calls a filesystem and allows a user to select a file to be used as the print target, and attaches the selected file to an e-mail. Note that the print request generating unit 22 may be omitted if the user is allowed to input the e-mail address that combines the domain name of the pre-registered print request control server 1 and the communication identifier of the wireless terminal 2 into the mail communication unit 21, which is a standard MUA.

### Print Request Control Method

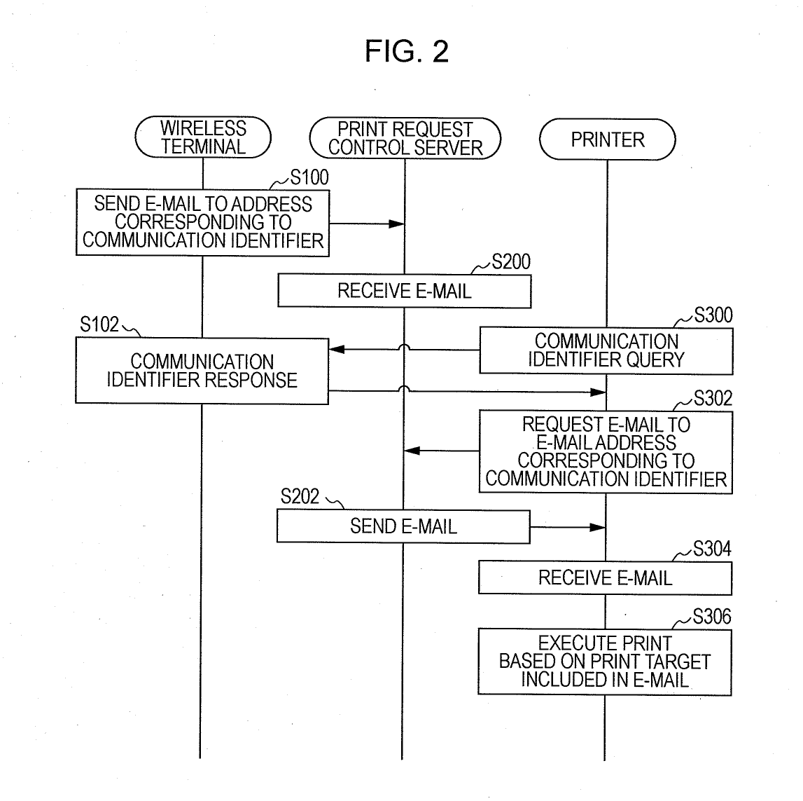

Next, a print request control method using the aforementioned printing system will be described based on FIG. 2.

First, a user that wishes to output printed material using the printer 3 operates the print request generating unit 22 and sends, from a given wireless terminal, an e-mail (print request mail), including a print target, to the e-mail address that corresponds to the communication identifier of that wireless terminal and that includes the domain name of the print request control server 1, via the mail communication unit 21 (S100). In the print request mail, text data, image data, or the like can be included in the body or in an attached file as the print target. As long as the user of the wireless terminal 2 is in an environment where he or she can connect to the Internet, he or she can send the print request mail from any location.

When the print request mail has been sent from the wireless terminal 2, the print request control server 1 receives that print request mail via over the Internet 4 and stores the print request mail (S200). Because the communication identifier of the wireless terminal 2 is included in the address of the e-mail that serves as the print request, the print request control server 1 stores the print target as print information in association with the communication identifier of the wireless terminal 2. Note that because the print information storage unit 12 receives and stores all of the e-mails sent to the domain assigned to the print request control server 1, it is desirable for the e-mails to be sequentially deleted after a set amount of time has passed following their reception, or to provide a limit on the number of e-mails that are stored and delete older e-mails in the case where a number of e-mails that exceeds the upper limit has been reached.

Meanwhile, the wireless terminal detecting unit 34 of the printer 3 periodically queries communication identifiers over the wireless LAN (S300). Specifically, the wireless terminal detecting unit 34 executes a broadcast that queries communication identifiers over the wireless LAN to which the printer 3 is connected, and in the case where another wireless terminal is present on that wireless LAN, receives the communication identifier from that other wireless terminal (S102). Because the process for querying communication identifiers is carried out periodically, when a wireless terminal 2 is present within the connectable range of the wireless LAN to which the printer 3 is connected, the communication identifier of that wireless terminal 2 is detected by the printer 3. Note that no processing is carried out in the case where a wireless terminal 2 is not present within the connectable range of the wireless LAN to which the printer 3 is connected.

Having detected the communication identifier of the wireless terminal 2, the printer 3 requests the print request control server 1 to forward the e-mail addressed to the e-mail address corresponding to the detected communication identifier (S302). In other words, when the wireless terminal 2 enters into the connectable range of the wireless LAN to which the printer 3 is connected, the print information receiving unit 31 inquires as to whether or not an e-mail addressed to the e-mail address corresponding to the communication identifier of the wireless terminal 2 is stored in the print request control server 1 by sending information that enables the communication identifier to be specified (or by sending the communication identifier itself) to the print request control server 1. Note that once a detected communication identifier has been inquired about, the communication identifier is no longer stored.

In the case where the e-mail for which the inquiry was made is stored, the print request control server 1 sends that e-mail to the printer that made the inquiry (S202). Specifically, in the case where the print request control server 1 stores the communication identifier of the wireless terminal 2 and the body or an attached file as a print request mail when the printer 3 has requested the forwarding of the e-mail sent to the e-mail address that includes the communication identifier of the wireless terminal 2, that print request mail is sent to the printer 3.

Upon receiving the e-mail sent to the e-mail address including the detected communication identifier (S304), the printer 3 executes printing based on the body or the attached file that serves as the print information (S306). Specifically, when the print information receiving unit 31 receives the e-mail including the body or the attached file that serves as the print information, the printing control unit 32 obtains the body and the attached file from the e-mail and converts those items into print data, and by controlling the printing unit 33 based on the print data, the print target sent to the print request control server 1 by the wireless terminal 2 is printed by the printing unit 33.

After this, the printer 3 notifies the print request control server 1 that printing is complete, and the print request control server 1 records the completion of the printing in history information; the process then ends. At this time, the print request control server 1 may notify the wireless terminal 2 that the printing has been completed.

According to the embodiment described thus far, the address of the e-mail used by the printer to receive the print target is not fixed, and is instead generated dynamically depending on the printer; this prevents the execution of wasteful printing resulting from the printer receiving spam. Furthermore, because the wireless terminal can send the print request mail without obtaining the e-mail address assigned to the printer, it is easy to use a printer that is present in the nearby vicinity of the wireless terminal.

### Second Embodiment

### Printing System

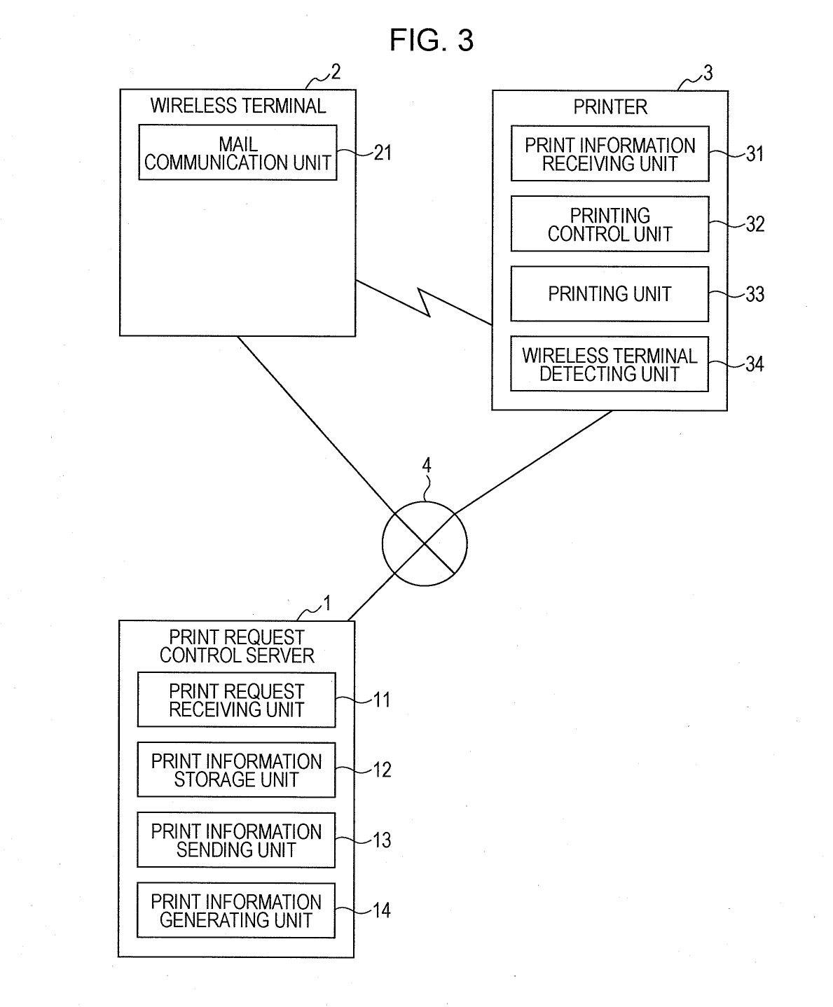

FIG. 3 is a block diagram illustrating a printing system according to a second embodiment of the invention. This embodiment differs from the first embodiment in that the print request generating unit 22 described in the first embodiment is not provided in the wireless terminal 2 and a print information generating unit 14 has been added to the print request control server 1.

In this embodiment, by executing a predetermined computer program, the print request control server 1 functions as the print information generating unit 14, which converts the body of an e-mail, a file attached thereto, or the like serving as a print target into print data serving as print information.

### Print Request Control Method

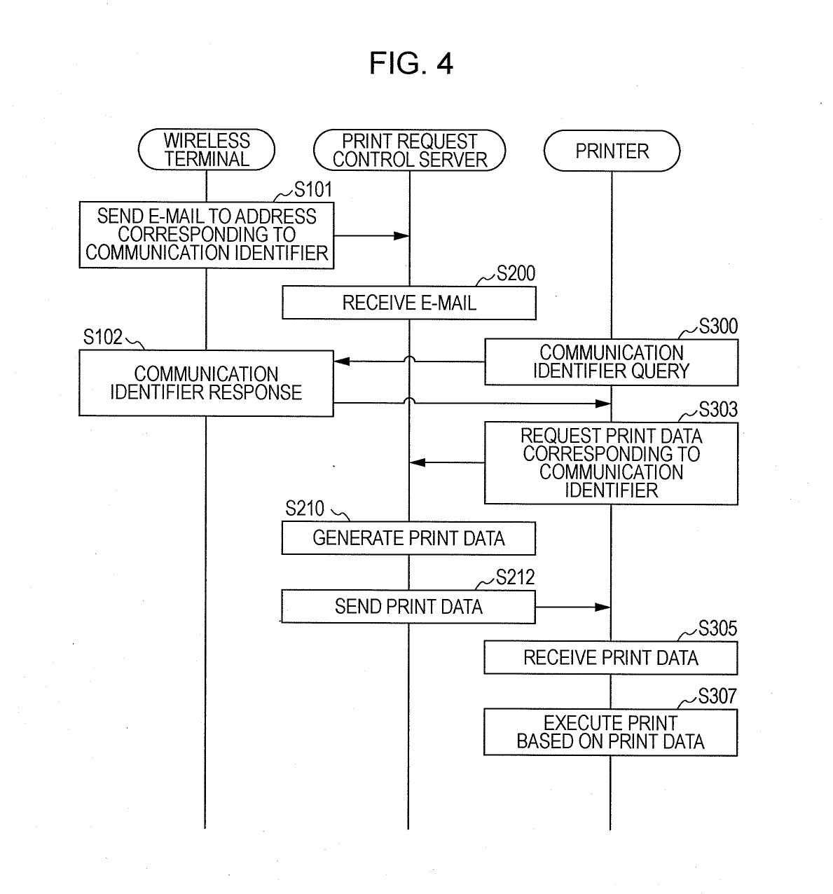

FIG. 4 is a sequence chart illustrating a print request control method that uses the printing system according to this embodiment.

First, a user that wishes to output printed material using the printer 3 operates the mail communication unit 21 and sends, from a given wireless terminal, an e-mail (print request mail), including a print target, to the e-mail address that includes the communication identifier of that wireless terminal and the domain name of the print request control server 1 (S101). The user of the wireless terminal 2, which does not have the print request generating unit 22 described in the first embodiment, launches a general e-mail sending/receiving program that functions as an MUA, and creates a print request mail by attaching a file as the print target or adding text to the body as the print target and setting an e-mail address that combines the communication identifier of the wireless terminal 2 with the domain name of the print request control server 1 as the destination; the user then sends the created print request mail.

Upon detecting the communication identifier of the wireless terminal, the printer 3 requests the print data that corresponds to the detected communication identifier (S303). Specifically, when the wireless terminal 2 enters into the connectable range of the wireless LAN to which the printer 3 is connected, the print information receiving unit 31 sends the communication identifier of the wireless terminal 2 to the print request control server 1 and requests the print request control server 1 to convert the body or attached file of the e-mail corresponding to the sent communication identifier into the print data.

When the print data is requested, the print request control server 1 generates the print data from the body or attached file of the e-mail corresponding to the communication identifier received from the printer 3 (S210), and sends the generated print data to the printer 3 (S212). Specifically, first, when the request for the print data is made, the print information generating unit 14 determines whether or not the e-mail that includes the communication identifier received from the printer 3 in its address is stored in the print information storage unit 12. In the case where the corresponding e-mail is stored in the print information storage unit 12, the print information generating unit 14 obtains the body or attached file serving as the print target from the corresponding e-mail, generates the print data compatible with the printer 3 that requested the print data from the obtained body or attached file, and sends the generated print data to the printer 3.

Upon receiving the print data corresponding to the detected communication identifier from the print request control server 1 (S305), the printer 3 executes printing based on the print data (S307). Specifically, when the print information receiving unit 31 receives the print data serving as the print information, the printing control unit 32 controls the printing unit 33 based on the print data, and the print target sent to the print request control server 1 by the wireless terminal 2 is printed by the printing unit 33.

According to this embodiment, the print target can be converted by the print request control server into print data suited to the printer and then sent to the printer as print information, and thus it is no longer necessary for the printer or wireless terminal to include functionality for converting print targets from a variety of formats into print data.

### Third Embodiment

### Printing System

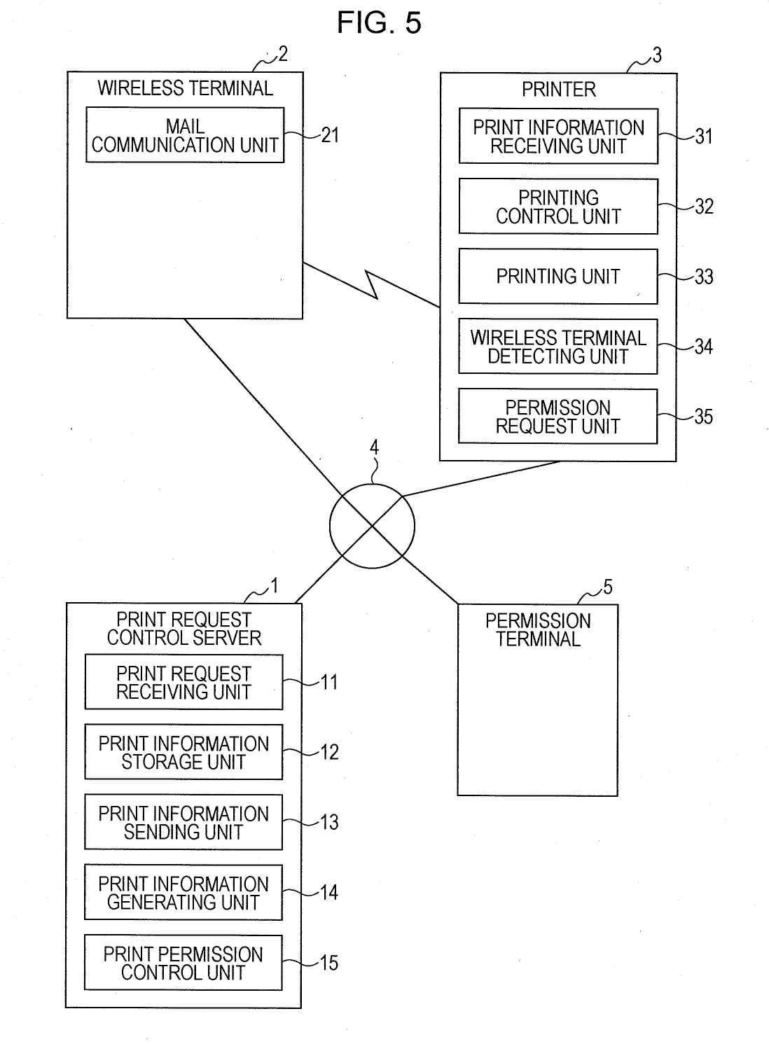

FIG. 5 is a block diagram illustrating a printing system according to a third embodiment of the invention. The printing system according to this embodiment differs from that in the second embodiment in that a permission terminal 5 that is connected to the Internet 4 is provided, the print request control server 1 includes a print permission control unit 15, and the printer 3 includes a permission request unit 35.

The permission terminal 5 is a communication terminal such as a personal computer, a mobile telephone, or the like that is administered by the same administrator as the printer 3, and a communication identifier such as an XMPP account name, an e-mail address, or the like is registered in the print request control server 1 in association with the printer 3. The permission terminal 5 has functionality for communicating with the print request control server 1 based on a protocol such as XMPP (eXtensible Messaging and Presence Protocol), SMTP (Simple Mail Transfer Protocol), or the like.

In this embodiment, by executing a predetermined computer program, the print request control server 1 functions as the print permission control unit 15, which determines whether or not to permit the execution of printing by the printer 3 every print request mail.

By executing a predetermined computer program, a computer provided in the printer 3 also functions as the permission request unit 35, which sends the communication identifier of a wireless terminal to the print request control server 1.

### Print Request Control Method

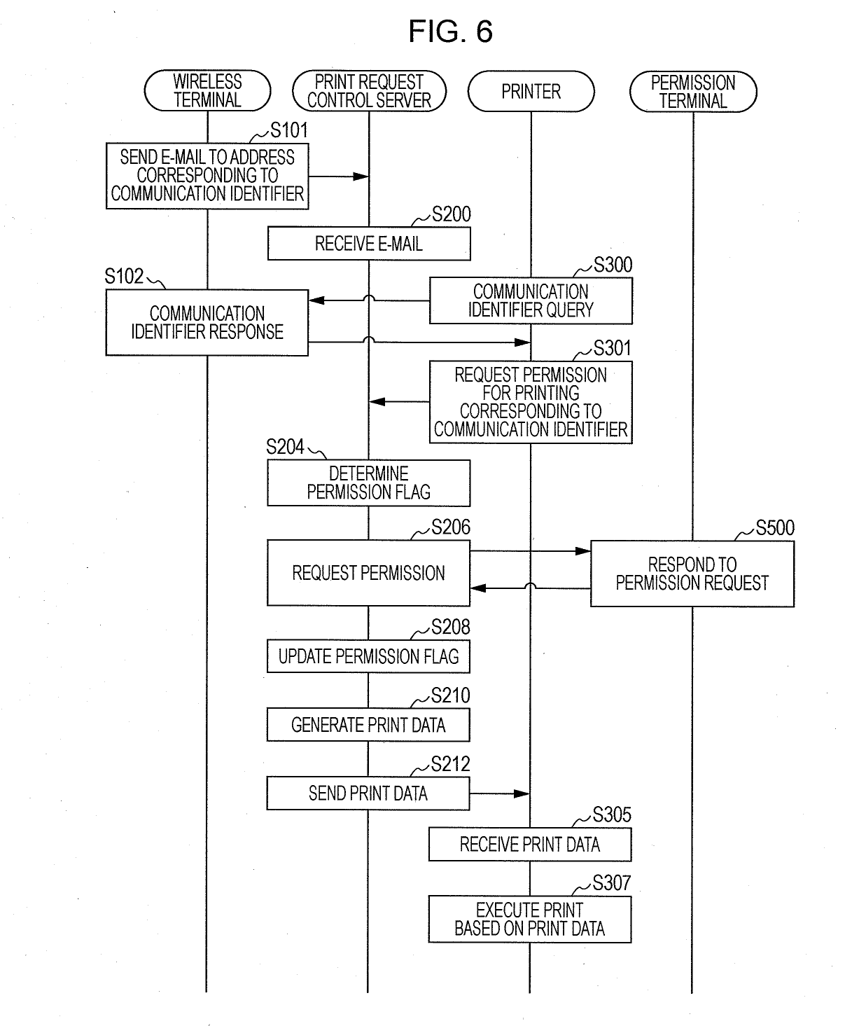

FIG. 6 is a sequence chart illustrating a print request control method that uses the printing system according to this embodiment.

Upon detecting the communication identifier of the wireless terminal, the printer 3 requests the print request control server 1 to permit printing corresponding to the detected communication identifier (S301). Specifically, when the wireless terminal 2 is detected as present within the connectable range of the wireless LAN to which the printer 3 is connected, the permission request unit 35 sends the communication identifier of the wireless terminal 2 and an identifier of the printer 3 to the print request control server 1, and requests print data based on the print request mail received by the print request control server 1 from the wireless terminal 2 that has the stated communication identifier.

In the case where the print request control server 1 has had the print data requested by receiving the communication identifier of a given wireless terminal from the printer and has also received the print request mail from a given wireless terminal, the print request control server 1 determines, based on a permission flag, whether or not to cause the printer to execute printing based on the print request mail sent from the wireless terminal (S204). The permission flag is binary data indicating “permitted” or “prohibited” on an identifier-by-identifier basis for printers registered in advance in the print request control server 1 and a communication identifier-by-communication identifier basis for wireless terminals registered in advance in the print request control server 1. In the case where the permission flag indicates “permitted”, the process moves to S210.

In the case where the permission flag indicates “prohibited”, the print request control server 1 makes a request to the permission terminal corresponding to the printer that detected the communication identifier of the wireless terminal and requested permission to print, in order to permit the execution of printing based on the received print request mail (S206). Specifically, the print permission control unit 15 requests permission for the printer 3 to execute printing by sending permission request information to the permission terminal 5 registered in association with the printer 3.

The user of the permission terminal 5 that received the permission request information determines whether or not to permit the execution of the printing based on the permission request information, and the result of the determination is sent to the print request control server 1 (S500). At this time, the user determines, based on the permission request information, whether or not to allow the execution of printing by the printer he or she manages in accordance with the print request mail sent from a communication terminal having a specific communication identifier, and this it is desirable for the permission request information to include information that serves as a basis for the determination.

For example, even in the case where the communication identifier of the wireless terminal 2 obtained from the printer 3 that is the source of the request for printing permission itself serves as the permission request information, the user can assume that the print request mail including the communication identifier of the wireless terminal 2 in its address has been sent from a wireless terminal communicating wirelessly with the printer 3 if the format of the portion in the permission request information corresponding to the communication identifier matches the format of the communication identifier. For example, in the case where a MAC address is used as a communication identifier, the user can assume that the print request mail is from a wireless terminal communicating wirelessly with the printer 3 if the permission request information is a 12-digit number expressed as a hexadecimal and permit the execution of printing based on that assumption, and prohibit the execution of printing if the permission request information is not a 12-digit number expressed as a hexadecimal.

In addition, for example, the print request control server 1 may generate the permission request information, based on the communication identifier obtained from the printer 3, in a manner that makes it easy for the administrator of the printer 3 and the permission terminal 5 to make the determination. Specifically, it may be determined whether or not the communication identifier obtained from the printer 3 is a 12-digit number expressed as a hexadecimal, and if such is the case, the permission request information for displaying a message reading, for example, “there is a request for printing permission from a person nearby your printer” in the permission terminal 5 may be generated, whereas if such is not the case, the permission request information for displaying a message reading “there is a request for printing permission from an unknown person” in the permission terminal 5 may be generated. Alternately, for example, the address of the sender of the print request mail may be included in the permission request information. When the address of the sender of the print request mail is included in the permission request information, the user can determine whether or not the print request mail can be trusted based on the domain name of the address of the sender. However, in this case, it is necessary for the printer 3 to send the address of the sender of the print request mail along with the communication identifier to the print request control server 1. Furthermore, the print request control server 1 may determine whether or not the print request mail can be trusted based on the address of the sender of the print request mail, and the result of that determination may be included in the permission request information.

When the determination result is received from the user of the permission terminal 5, the print request control server 1 updates the permission flag to “permitted” in the case where the determination result indicates “permitted”, and keeps the permission flag as “prohibited” in the case where the determination result indicates “prohibited” (S208).

In the case where the permission flag is determined to be “permitted” in S204 or the case where the permission flag has been updated to “permitted” in S208, the print request control server 1 notifies the printer 3 of the permission being made or having been made, generates print data from the body or attached file of the e-mail that includes the communication identifier received from the printer 3 in its address (S210), and sends the generated print data to the printer 3 (S212).

The printer 3 then executes printing based on the received print data.

On the other hand, in the case where the permission flag is kept as “prohibited” in S208, the print request control server 1 notifies the printer 3 of the prohibition, and the'process ends. Meanwhile, the print request control server 1 may notify the wireless terminal 2 of the prohibition as necessary.

According to this embodiment, when a wireless terminal enters into a range within which the wireless terminal can communicate with a printer registered in the print request control server 1 over a wireless LAN, a permission request is sent from the print request control server 1 to a permission terminal administered by the administrator of the printer so that printing is executed automatically in response to a print request from the wireless terminal. When the administrator of the printer has permitted the printing based on the print request mail, that printer can be caused to execute printing thereafter even if the wireless terminal is outside the range within which the wireless terminal can communicate with the printer over the wireless LAN, by sending the print request mail from the wireless terminal.

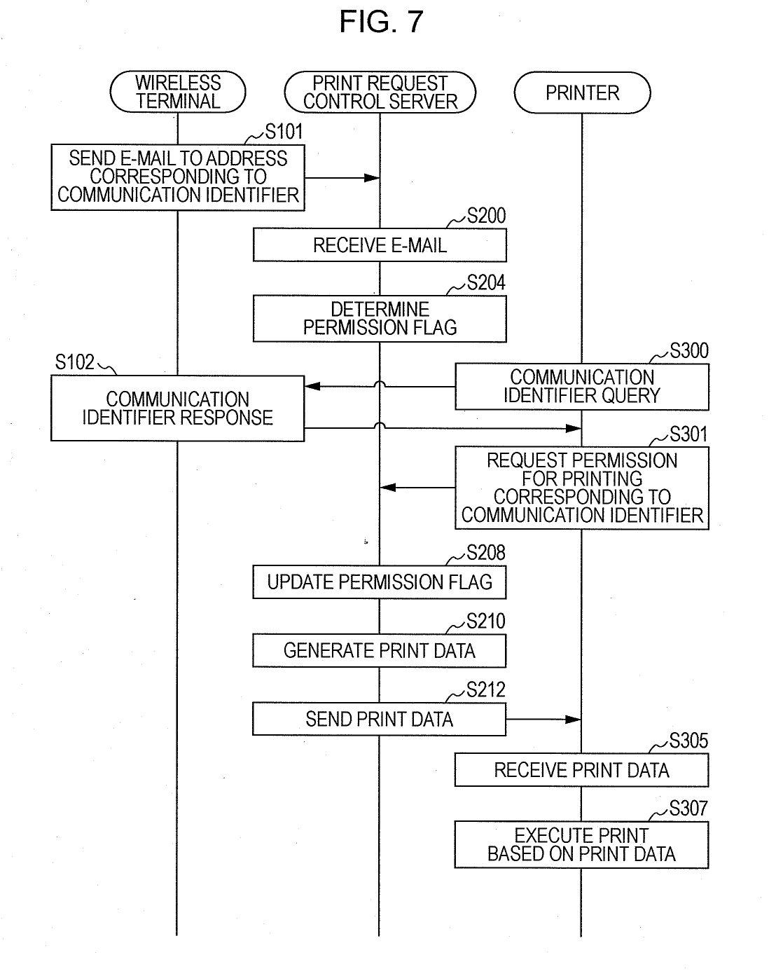

Note that printing can be permitted by default in response to print request mails from wireless terminals that have a history of entering into a range within which the wireless terminal can communicate with the printer over the wireless LAN. FIG. 7 illustrates the flow of the print request control method in such a case. Specifically, upon receiving the communication identifier sent from the printer 3 (S301), the print request control server 1 may update the permission flag corresponding to the identifier of the printer 3 that sent the communication identifier and the communication identifier received from the printer 3 to “permitted” (S208) without the permission request information being sent to the permission terminal 5.

### Other Embodiments

In addition to the embodiments described thus far, the invention can be carried out in a variety of ways, by combining the aforementioned embodiments, combining those embodiments with the embodiments described hereinafter, and so on; thus the technical scope of the invention is not limited to the embodiments described above.

For example, although the aforementioned embodiments describe examples in which the print target included in the print request mail is automatically printed when the communication identifier of the wireless terminal that sent the print request mail is detected by the printer, an execution instruction from the user of the wireless terminal may be accepted by the printer prior to the printing. Specifically, when the printer receives the print request mail, the printer displays the e-mail address of the source or the destination of the print request mail in a selectable manner on a display provided in the printer. Then, when the user instructs the printing to be executed by selecting a displayed e-mail address, the printer may execute the printing of the print target in the print request mail that corresponds to the selected e-mail address. Through this, printing based on the print request mail can be prevented from being executed by a printer that the user does not intend to use.

In addition, the print request control server may notify the printer of the communication identifier of the wireless terminal that is the source of the print request along with the print data, and the printer may then confirm whether or not the notified communication identifier and the communication identifier detected by the wireless terminal detection unit are the same. In this case, the printing is executed if the identifiers are the same, whereas the printing is not executed if the identifiers are different; this ensures that print data sent erroneously is not printed. Furthermore, the printer may detect the communication identifier using the wireless terminal detection unit after the notification of the communication identifier and the reception of the print data have started, and may then confirm whether or not the notified communication identifier and the communication identifier detected by the wireless terminal detection unit are the same. Through this, the printing can be prevented from being carried out in the case where the wireless terminal has exited the range within which detection is possible.

In addition, for example, when the printer makes a query for the print request mail to the print request control server, the print request control server may be notified of model information of the printer. If the print request control server is provided with functionality for generating print data in accordance with different models, print data that is optimized for the printer can be generated based on the model information obtained from the printer, and that print data can then be sent to the printer. Through this, even if the printer does not have functionality for generating print data, it is still possible to use the printer from any wireless terminal by sending, through e-mail, the print target in a generic data format such as text data, image data, or the like.

In addition, the printer 3 may query the communication identifier using a system aside from wireless LAN, such as infrared communication or the like.

In addition, as long as the communication identifier of the wireless terminal is included in the print request mail, the identifier need not be included in the e-mail address. For example, the communication identifier of the wireless terminal may be included in the subject, body, or the like of the print request mail.

In addition, in the second embodiment or in the third embodiment, the print data may be generated in response to receiving the print request mail without waiting for a request from the printer, as long as the printer that is compliant with the stated system is capable of printing print data that has a shared format.

The wireless terminal may make the print request using a method aside from e-mail; furthermore, any other information may be employed as long as that information enables the printer to notify the communication identifier and enables the wireless terminal to be specified, and the information may also be information that enables those items to be derived.

Furthermore, in the third embodiment, a printer executes printing in response to a print request mail sent from an area where wireless communication is not possible with the printer even though information for specifying the printer that is to execute the printing is not included in the print request mail; thus it is conceivable that a plurality of printers will execute printing in response to the sending of a single print request mail. Accordingly, the identifier of the printer may be included, along with the communication identifier of the wireless terminal, in the address, subject, body, or the like of the print request mail in order to specify the printer that is to execute the printing. Specifically, if, for example, the communication identifier of the wireless terminal 2 is “xxxxxx”, the identifier of the printer 3 is “zzzzz”, and the domain name of the print request control server 1 is “yyyyyy”, the print request mail may be sent using an address of “zzzzz.xxxxxx@yyyyyy”. This makes it possible for the print request control server 1 that receives the print request mail to cause only the printer 3 to execute the printing. Note that when the printer 3 detects the communication identifier of the wireless terminal 2, the communication identifier of the printer 3 is sent from the printer 3 to the wireless terminal 2, and thus the wireless terminal 2 can obtain the communication identifier of the printer 3.

In addition, other information regarding the print request mail may be included in the permission request information sent by the print permission control unit 15, to serve as a basis for the determination carried out by the user of the permission terminal 5. Such other information regarding the print request mail includes, for example, the time when the print request mail was sent, the content (subject, body, attached file, or the like) of the print request mail, the number of pages the content of the print request mail is to be printed on, and so on. The user of the permission terminal 5 can then decide whether to permit or prohibit by determining whether the time at which the print request mail was sent indicates that the print request mail was sent from the vicinity of the printer, whether the content of the print request mail will not be problematic if printed, whether the mail is from a person who can be permitted without problems, whether the content of the print request mail indicates that the amount of printing will not be problematic, and so on.

What is claimed is:

1. A printing system that is provided a print request unit to send a print request including an identifier and a print target, printing is carried out based on a print request sent from a given wireless terminal that is identified by the identifier, the printing system comprising:
a print request control server including a print request receiving unit that receives the print request and a print information sending unit that sends print information corresponding to the print target in association with the identifier; and
a printer including a wireless terminal detecting unit that detects the identifier of the given wireless terminal, a print information receiving unit that receives the print information corresponding to the detected identifier from the print request control server, and a print control unit that controls the printing based on the print information.

2. The printing system according to claim 1,
wherein the print information receiving unit notifies the print request control server of the detected identifier and receives the print information corresponding to the notified identifier from the print request control server; and
the print information sending unit sends, as the print information corresponding to the identifier, print information corresponding to the print request sent including the identifier notified by the print information receiving unit.

3. The printing system according to claim 1,
wherein the print request is an e-mail whose destination is an e-mail address that includes the identifier.

4. The printing system according to claim 1,
wherein the print information includes the print target itself.

5. The printing system according to claim 1,
wherein the print request control server further includes a print information generating unit that generates the print information by converting the print target.

6. A printer comprising:
a wireless terminal detecting unit that detects a communication identifier of a given wireless terminal;
a print information receiving unit that receives print information corresponding to the detected communication identifier; and
a print control unit that controls printing based on the print information.

7. A print request control server comprising:
a print request receiving unit that receives, from a given wireless terminal identified by a communication identifier, a print request that includes the communication identifier and a print target; and
a print information sending unit that sends, to a printer that has detected the communication identifier of the given wireless terminal, print information corresponding to the print target in association with the communication identifier.

8. The printer according to claim 6,
wherein the print information receiving unit makes a notification of the detected identifier and receives the print information corresponding to the notified identifier.
